(19) United States
(12) Patent Application Publication
(10) Pub. No.: US 2011/0215909 A1
(43) Pub. Date: Sep. 8, 2011

(54) STRUCTURE INCLUDING AT LEAST TWO INTEGRATED MICROCIRCUIT DEVICES WITH CONTACTLESS COMMUNICATION

(75) Inventors: Sandrine Rancien, La Murette (FR); Thibault Le Loarer, Pommier De Beaurepaire (FR); Henri Rosset, Le Pin (FR)

(73) Assignee: ARJOWIGGINS SECURITY, PARIS (FR)

(21) Appl. No.: 13/062,627

(22) PCT Filed: Sep. 7, 2009
(86) PCT No.: PCT/IB2009/053898

§ 371 Date: May 24, 2011

(30) Foreign Application Priority Data
Sep. 12, 2008 (FR) 0856141

(51) Int. Cl. H04Q 5/22; G06K 19/073

(52) U.S. Cl. 340/10.1; 235/492

(57) ABSTRACT

A structure including at least two separate integrated microcircuit devices with contactless communication, each including at least one chip and at least one antenna, said at least two integrated microcircuit devices being placed in or on the structure such that any simultaneous reading of more than one of the integrated microcircuit devices by an external reader is impossible in at least one position of the structure relative to the external reader.

The present invention relates to the field of security and/or identity documents.

### BACKGROUND

In order to combat counterfeiting or falsification of security and/or identity documents and in order to increase the level of security of such documents, it is known to incorporate integrated microcircuit devices, in particular RFID (radio frequency identification devices) into them. Such devices, for example in the form of a chip associated with an antenna, can store and possibly modify information belonging to the bearer or to the item to which it pertains, to the type of document issued or to a record of events.

As an example, plastics material identity cards are known that include a contactless RFID integrated microcircuit device produced from an assembly of polymer layers; in the event of failure or deterioration of the

RFID device, it can be difficult if not impossible to read the data contained in the device so that identifying the bearer of the identity card may become difficult if not impossible.

Furthermore, the data contained in the RFID device incorporated in such cards is generally linked to a specific database or linked to a single application program and in general can carry out just one authentication of the document as a function of the data contained in that device.

There are also contact chip cards that are known as multi-application cards, such as Visa bank cards into which an electronic wallet of the Moneo™ type is incorporated, or electronic badges that allow access to shows and also allow public transport to the shows to be used free of charge. Said cards have a single contact chip or a dual chip that is capable of functioning by contact or contactless, that chip being provided with various application programs.

Such a multiple-application contact chip card is not always desired, especially by the suppliers of application programs who, for security reasons, prefer not to share the same chip with other, different, application program suppliers.

There is a risk that a given application program could provide access to data relating to a different application program present on the same multiple-application contact chip. For that type of multiple-application chip, it is thus necessary to ensure complete isolation between the various compartments of the chip dealing with the various application programs.

The term “application program” means a set of digital programs intended to assist a user in executing an operation. In particular, it means software or a set of software.

### SUMMARY

There is a need for further strengthening the security and the processes for identifying security and/or identity documents, in particular to increase the difficulty of counterfeiting such documents.

In particular, there is also a need for drawing advantage from using several independent RFID devices on the security or identity document in order to combat falsifications or counterfeiting, in order to overcome problems with failure and with deterioration of integrated microcircuit devices.

There is also a need for “multiple-application” security and/or identity documents having a plurality of on-board contactless RFID integrated microcircuit devices that are independent, which devices are capable of controlling different applications and possibly addressing different databases, and thereby having a variety of uses or functions.

One of the aims of the present invention is thus to propose a security structure that has a high level of security and resistance to falsification or counterfeiting and that enables multiple usage of the security structure, especially of several mutually independent application programs.

Thus, in one of its aspects, the invention provides a structure including at least two distinct integrated microcircuit devices with contactless communication, each comprising at least one chip and at least one antenna, said at least two integrated microcircuit devices being disposed such that, in at least one position of the structure relative to an external reader, any simultaneous reading of more than one of the integrated microcircuit devices by the external reader is impossible.

Positioning of the structure in order to allow at least one integrated microcircuit device to be read by the external reader may be carried out in a variety of manners that are themselves known, for example by inserting the structure into a recess of the external reader, by moving the structure relative to the external reader, or by placing one of the faces of the structure against the external reader, among others.

Simultaneous reading of more than one of the integrated microcircuit devices by an external reader may be impossible in any position of the structure relative to the external reader.

The structure may thus be flexible or rigid in order to facilitate or not facilitate reading of one or more integrated microcircuit devices.

Preferably, the at least one integrated microcircuit device of the structure may be read without deforming the structure, in particular without deforming the structure mechanically, e.g. by folding it.

The external reader may be put into communication with the structure.

The external reader may be configured to read each of the integrated microcircuit devices, and in particular configured to function in accordance with standard ISO 14443.

The invention also provides a structure including at least two integrated microcircuit devices with contactless communication, the integrated microcircuit devices being separated in pairs by a distance greater than the sum of the read distances for reading the integrated microcircuit devices by an external reader, in particular greater than 10 millimeters (mm), and/or being separated from each other by an electromagnetic interference system.

The distance between the two integrated microcircuit devices may correspond to the distance separating the chips of the devices, in particular the planes and/or centers of the chips, or the distance separating the antennas of the devices, in particular the planes and/or the centers of the antennas.

In particular, the integrated microcircuit devices may be adjacent to opposite ends of the structure or they may be positioned on opposite faces of the structure, one device being present on the recto face of the structure and the other device on the verso face.

The invention is capable of preventing the data contained in the two integrated microcircuit devices from being read simultaneously by the external reader without any need for “anti-collision” systems in the integrated microcircuit devices. Examples of such systems are described in standards ISO 14443, ISO 15693, and ISO 18000.

The invention also makes it possible to access data and/or application programs of a single integrated microcircuit device without requiring a terminal-type external reader that is capable of selecting the application program that is to be operated.

In particular, the external reader is capable of reading only one of the integrated microcircuit devices in at least one position of the structure relative to the external reader, for example when the user presents the recto or the verso of the structure to the external reader, or when the user presents one or other end of the structure to the external reader.

In particular, in at least one position of the structure relative to the external reader, only the application programs relating to one of the integrated microcircuit devices are active, while the application programs relating to the other integrated microcircuit device are inoperative.

By means of the invention, it is possible to benefit from a security structure having at least two levels of security linked to two integrated microcircuit devices, thus, for example, allowing the authentication process to be made more secure and increasing the difficulty of counterfeiting.

By means of the invention, it is also possible to authorize reading of one of the integrated microcircuit devices only after the other integrated microcircuit device has been read, in particular for authorization to depend on the result of that first reading, with reading of the first RFID device thus acting as a Basic Access Control for reading the second RFID device.

By means of the invention, it is also possible to provide a structure that is capable of carrying out a plurality of applications, in particular a specific application associated with each contactless integrated microcircuit device. As an example, the structure may be incorporated into a security and/or identity document such as an access card, for example, to allow use both as a photocopy card and as a canteen card.

The structure may also incorporate a first integrated microcircuit device on its recto face and a second integrated microcircuit device on its verso face and be integrated into an interactive playing card, such that the playing card that contains it presents different applications as a function of the face of the card that is to be presented to an external reader (for example a function to allow a player to access a game and a “buy life” or “buy weapons” function for the player in question).

In another embodiment of the invention, the structure may incorporate a first integrated microcircuit device at one of its ends and a second integrated microcircuit device at its other end, such that the access card that contains the structure must be presented to the external reader in a specific orientation as a function of the desired use, especially as a student card or as a library card.

The invention also makes it possible to benefit from a structure having two RFID devices with content that is redundant or two RFID devices authorizing access to the same database, thus overcoming problems with failure and/or deterioration that may occur in one of the contactless RFID devices.

In one embodiment of the invention, the structure includes two integrated microcircuit devices on either side of an electromagnetic interference system that is thicker than it is wide. Each device may be sandwiched in an assembly of two inner layers, for example formed from a synthetic material. The assemblies of inner layers may be separated by the interference system. By way of example, the interference system is a strip of metal, for example aluminum. The assemblies of inner layers and the interference system may be sandwiched between outer layers. Spacers may connect these outer layers to the periphery of the structure.

### Integrated Microcircuit Device

Contactless integrated microcircuit devices result from associating a chip with at least one antenna.

A chip comprises, for example, a semiconductor base, in general taken from a doped silicon wafer, sometimes produced from a semiconductor polymer, and also in general includes a memory or even one or more microprocessors so that data can be processed. In order to function, it may receive energy from a battery or a cell or it may be powered from a source of electricity via a contact and/or in a contactless manner, i.e. it may be powered remotely by means of a communications interface via an antenna. Chips with an antenna are known as “transponders” and in general use radio frequency or ultra-high frequency waves.

When the integrated microcircuit device is said to be “passive”, the chip is powered contactlessly in inductive or capacitative manner.

When the integrated microcircuit device is said to be “active”, the chip may include a battery, also termed a “micro-battery”, integrated into its micro circuit, or it may be connected to a micro-battery integrated into the structure. The term “battery” means an electrochemical source of energy, rechargeable or otherwise.

The chip may also be powered by means of a photovoltaic or a piezoelectric system.

At least one integrated microcircuit device may be capable of communicating with an external reader. The term “external reader” means any device that allows communication with an integrated microcircuit device and that is capable of powering it remotely, in particular for passive systems, of activating it, of authenticating it, of reading data it contains, of receiving said data and if appropriate, of modifying it, or even of deleting it in part or completely. The external reader may function remotely or it may require contact.

The two RFID devices are in particular contactless integrated microcircuit devices advantageously adapted to contactless communication technology, for example as described in the standard ISO 14443.

It is also possible for one of the integrated microcircuit devices of the invention to be capable both of contactless communication and of communication by contact, allowing both contactless and contact reading. In particular, this device may include two electronic modules, one for contact technology (standard ISO 7816), the other for contactless technology (standard ISO 14443), e.g. for a hybrid chip card or a double faced contact/contactless electronic module for a dual chip card.

At least one of the integrated microcircuit devices may advantageously include an on-board antenna on the integrated microcircuit, the device being of the AOB (antenna on-board) type, for example.

Chips of the “MM chip” type supplied by the supplier FEC use technology corresponding to standard ISO 14443, but they are also capable of using technology corresponding to standard ISO 18000-6c, said chips being able to communicate at frequencies in the range 13.56 kilohertz (kHz) to 2.45 gigahertz (GHz).

In addition to an on-board antenna, at least one of the integrated microcircuit devices may also advantageously include, for example, a coupling antenna, more routinely known as a “booster antenna”, coupled to or connected to the integrated microcircuit device, which antenna enables the distance at which the integrated microcircuit can be read by an external reader to be increased.

Pairs of booster antennas for the integrated microcircuit devices may be separated by a distance greater than the sum of the distances for reading the integrated microcircuit devices with an external reader, in particular by more than 10 mm, and/or they may be separated from each other by an electromagnetic interference system.

The two integrated microcircuit devices may optionally be positioned facing each other, in a symmetrical or non-symmetrical manner, in particular relative to the electromagnetic interference system and/or relative to a longitudinal or transverse axis of the structure.

The antenna of at least one integrated microcircuit device may be of the filament, printed, in particular by silk screen printing, etched, bonded, transferred, or chemically deposited type or of the type deposited by ultrasound, or of the type produced by electro-plating, or carried by the integrated microcircuit device or devices.

The antenna of at least one integrated microcircuit device may be carried by a constituent layer of the structure, for example a fibrous layer, a polymer layer or an adhesive layer.

The antenna may be located on one of the faces of the structure or on a constituent layer of the structure, or it may be completely incorporated within it.

The antenna may also be formed on one face of a constituent layer of the structure before assembling said layer with another layer of the structure.

It may be possible to read one of the integrated microcircuit devices only after reading the other integrated microcircuit device. In particular, it may be possible to read one of the integrated microcircuit devices by an external reader only if the result of reading the other integrated microcircuit device by the external reader corresponds to an expected result.

The integrated microcircuit devices of the invention may contain data that is identical or different. They may also allow access to application programs or to databases that are identical or different.

When the integrated microcircuit devices contain identical data or allow access to identical application programs or databases, and in the event of deterioration or failure of one of the integrated microcircuit devices, the invention may advantageously enable the structure to be identified and/or used in particular via the other integrated microcircuit device.

When the integrated microcircuit devices contain different data and/or allow access to different application programs or databases, the structure of the invention may have multiple applications, for example allowing different uses or different identification processes as a function of which integrated microcircuit device is being read by an external reader.

At least one of the integrated microcircuit devices, and preferably both integrated microcircuit devices, may be located on one of the faces of the structure or of a constituent layer of the structure.

In a preferred embodiment, at least one of the integrated microcircuit devices, and preferably both integrated microcircuit devices, may be at least partially incorporated in the structure or in a constituent layer of the structure.

The two integrated microcircuit devices may be located on respective different faces of the structure or of one or both constituent layers of the structure.

The two integrated microcircuit devices may be at least partially incorporated in two different constituent layers of the structure.

At least one integrated microcircuit device, and preferably both integrated microcircuit devices, may be at least partially visible on one of the faces of the structure.

In one embodiment, at least one integrated microcircuit device, and preferably both integrated microcircuit devices, may be flush with at least one face of the structure or of a constituent layer of the structure, or even with each of the faces of the structure or of a constituent layer of the structure.

The two integrated microcircuit devices may also be flush with respective different faces of the structure or with one or two constituent layers of the structure.

At least one of the integrated microcircuit devices may be visible on the structure. As an example, the structure may include a transparent or translucent material allowing at least one of the integrated microcircuit devices to be seen.

The two integrated microcircuit devices may be separated from each other by a distance that is sufficient to prevent any simultaneous reading of both integrated microcircuit devices by the same external reader. The distance may in particular be greater than the sum of the read distances of the integrated microcircuit devices relative to an external reader. The distance separating the two integrated microcircuit devices may, for example, be greater than 10 mm.

In one embodiment, at least one of the integrated microcircuit devices may include a booster antenna increasing the distance at which the integrated microcircuit can be read by an external reader.

When the structure does not include an electromagnetic interference system, the booster antenna is selected such that the sum of the read distances of the integrated microcircuit devices relative to an external reader remains smaller than the distance separating the integrated microcircuit devices.

By way of example, each of the two integrated microcircuit devices may be located at a different end of the structure. In particular, the integrated microcircuit devices may be adjacent to the opposite ends of the structure.

In one embodiment, at least one of the integrated microcircuit devices may be carried by a filament or a strip incorporated into the structure, the filament or strip possibly being constituted by a polymer, paper, fabric, knit, or a mixture of these constituents, for example.

In another embodiment, at least one of the integrated microcircuit devices may be carried by a transparent security film to protect variable data, laminated onto the outer face of a constituent layer of the structure.

In yet another embodiment, at least one of the integrated microcircuit devices may be carried by a security foil having an optical effect, laminated with or without the addition of an adhesive onto the outer face of a constituent layer of the structure.

### Electromagnetic Interference System

The two integrated microcircuit devices may also be separated from each other by an electromagnetic interference system. In particular, the two integrated microcircuit devices may be located either side of the electromagnetic interference system.

The term “electromagnetic interference system” means an element that can disturb coupling of at least one of the two contactless integrated microcircuit devices with the reader when the structure including the RFID devices is brought in front of the reader such that an external reader can only read one of the integrated microcircuit devices.

The electromagnetic interference system may, for example, be disposed between the two contactless integrated microcircuit devices and only allow one of the contactless integrated microcircuit devices to be read, in particular that which is on the side of the structure placed in front of the reader, thereby blocking communication of the reader with the second contactless integrated microcircuit device in particular by totally or partially blocking the electromagnetic field generated by the external reader and remotely powering the device, when the device is a passive device.

The electromagnetic interference system may include means for attenuating electromagnetic coupling of the magnetic material, conductive material, or resonator circuit type.

The electromagnetic interference system may be formed with the assistance of at least one of the following elements:
a support, in particular a film, formed from plastics material laminated with at least one metal film, for example an aluminum or copper film;
a metallized support, in particular metallized by vacuum metallization or by chemical treatment, the support possibly being selected from a film of plastics material, a paper, a textile, or a nonwoven material;
a support, in particular formed from paper or plastics material, filled with an electrically conductive filler such as carbon black or carbon fibers, metal fibers, metallized fibers, metal flakes, a powder formed from a metal or with a conducting agent such as a salt, in particular sodium chloride or ammonium chloride;
a support formed by interlaced filaments, in particular a woven material, a knit, a screen, at least some of the filaments being formed from an electrically conductive material, for example a metal;
a nonwoven support comprising conductive fibers, for example metal fibers, possibly mixed with synthetic fibers;
a support, especially a film, having a perforated metal structure;
a metal film;
an electrically conductive varnish or an electrically conductive paint, for example based on copper, nickel or silver;
an electrically conductive polymer such as polypyrrole, polyacetylene, or polythiophene;
an electrically conductive adhesive; and
a material comprising carbon nanotubes.

The electromagnetic interference system may also be formed using at least one of the following elements:
a support, especially a film, formed from plastics material laminated with at least one magnetic film;
a support with a magnetic coating, for example vacuum deposited or deposited by chemical treatment;
a support, in particular formed from paper or plastics material, filled with a magnetic filler such as ferrites;
a support, in particular a film, having a perforated magnetic material structure;
a magnetic film;
a magnetic varnish or paint;
an adhesive including magnetic particles; and
a material including magnetic nanoparticles.

The electromagnetic interference system may extend over the surface of the structure in a partial or complete manner.

In one particular case, the interference system may have a variety of shapes and/or dimensions, adapted to allow contactless reading and/or writing to one of the RFID devices when the structure is presented to the reader in a certain orientation.

As an example, the electromagnetic interference system may have a rectangular, square or curved contour, for example circular or elliptical.

The electromagnetic interference system may form a solid pattern. In a variation, the electromagnetic interference system may be in the form of a strip forming a closed loop, said strip being substantially rectangular or circular, for example. In one particular case, the electromagnetic interference system may take the form of an antenna type resonator circuit.

In another embodiment, the electromagnetic interference system may form a perforated pattern, for example a grid pattern.

The electromagnetic interference system may define at least one pattern contributing to the appearance of the structure, said pattern being an alphanumeric character, a symbol, a logo or a design, for example.

The electromagnetic interference system may be totally or partially transparent, translucent, or opaque.

Electronic Devices other than Contactless Integrated Microcircuit Devices

At least one contactless integrated microcircuit device may be associated with, for example connected to, one or more electronic device(s) selected from the following list:
a light-emitting system, in particular LED or OLED;
a display device, for example a screen;
a sensor;
a booster antenna;
a switch; and
a contact type integrated microcircuit device.

At least one of the integrated microcircuit devices may include one or more of the on-board electronic devices mentioned above. In a variation, the electronic device or devices may be independent of the integrated microcircuit device, and may preferably be linked to the integrated microcircuit device via a hard wired, optical or radio connection, for example by inductive coupling.

The electronic device or devices may be supplied with electricity via a battery present on one of the integrated microcircuit devices, in particular via an on-chip micro-battery.

The electronic device or devices may also be powered by an external cell or battery, not present on one of the integrated microcircuit devices, for example a flexible thin layer battery distinct from a chip or by a photovoltaic cell, or a piezoelectric device, for example at least partially printed.

The electronic device or devices may also be powered by capacitative or inductive coupling, for example during a communication between one of the integrated microcircuit devices and an external reader.

The electronic device or devices, and possibly the associated power supply devices, for example one or more batteries, may be housed in the thickness of one of the layers of the structure or, in a variation, may be produced by printing onto one of the layers of the structure.

In one embodiment, the electronic device or devices are added to the structure as an additional security means that may optionally interact with the outside. As an example, the electronic device may be a switch that actuates a light-emitting device.

The electronic device or devices may correspond to a detector. The detector may be configured to detect a change of at least one physico-chemical parameter. Detection may be made outside the reading range of an external reader capable of obtaining from one of the integrated microcircuit devices at least information relating to said change, and the integrated microcircuit device may be configured to inform the external reader during communication therewith, about an attempt at attacking the physical integrity of the structure following detection of a corresponding change in said at least one physico-chemical parameter.

The integrated microcircuit device is advantageously capable of storing the change or changes in a memory.

The term “physico-chemical parameter” means a parameter or an intrinsic characteristic property of the structure or of an element present in or on the structure, the value of that parameter or that property being modified during an intrusion or a physical violation of the structure.

In another embodiment of the invention, the electronic device or devices are incorporated into the structure with the aim of adding a particular function, for example associated with one of the integrated microcircuit devices or with another electronic device. As an example, an electronic device may be a photovoltaic cell that recharges a battery used by a sensor.

### Structure

The structure of the invention may be completely opaque, completely transparent, or partially transparent, especially by means of the presence of a transparent or translucent zone.

The structure of the invention may be a mono-layer or multi-layer, being constituted, for example, by one or more constituent layers, especially fibrous and/or polymeric.

The constituent layers of the structure may have thicknesses that are identical or different, for example in the range 50 micrometers (μm) to 400 μm.

The structure may include a fibrous layer. In particular, the fibrous layer may be based on cellulose fibers, for example cotton fibers, and/or on synthetic fibers, for example polyamide and/or polyester fibers, and/or natural organic fibers other than cellulose, and/or mineral fibers.

The structure may also include a polymer layer, for example in the form of a film, in particular a foamed or non-foamed film. In particular, the polymer layer may comprise polyethylene (PE), polyvinyl chloride (PVC), polyethylene terephthalate (PET), polycarbonate (PC), polyester carbonate (PEC), polyethylene terephthalate glycol (PETG), an acrylonitrile-butadiene-styrene copolymer (ABS) or a light-collecting film, for example of the “waveguide” type, for example a luminescent film based on polycarbonate marketed by BAYER under the trade name LISA®.

The structure may also include a co-extruded layer produced from at least one polymer material, and comprising a core layer and at least one skin layer, the core layer including recesses. The “core layer” corresponds to a base layer that is further from the surface of the layer than the “skin layer” that corresponds to a surface layer. The layer may in particular be produced as described in applications EP 0 470 760 and EP 0 703 071. As an example, the layer employed may be based on polyethylene marketed under the trade name POLYART® by the supplier ARJOWIGGINS or a polyethylene film filled with silica marketed under the trade name TESLIN® by the supplier PPG INDUSTRIES.

The structure may have a final thickness in the range 0.1 mm to 3 mm, preferably in the range 200 μm to 880 μm.

The structure may have thickness that is constant or that varies; in particular, the structure may be thinner at the edges.

The structure may be incorporated into a security and/or identity document. In particular, the structure may correspond to or be integrated in a leaf of a passport.

The structure may include a transparent pouch, for example a hot laminatable polyester pouch coated with polyethylene such as that sold under the trade name Fasfilm by the supplier Fasver.

The structure may also include a laminate in the form of two transparent films laminated directly onto the outer faces of the structure, said films adhering to the structure via an adhesive or without an adhesive by fusion or welding. In one particular case, the two transparent films are fused along the edges.

The structure may include a plurality of identifiers on one of the constituent layers of the structure, in particular on the recto and verso faces of the structure, respectively associated with the integrated microcircuit devices, in particular with data contained in each of the integrated microcircuit devices. In particular, the identifiers may be different for each integrated microcircuit device.

In this manner, it is possible to identify the function or functions of the structure resulting from the data contained in the integrated microcircuit devices, for example with multiple-application cards for use as a canteen card and as a photocopy card, or as a student card and library card, among others, as a function of the identifier or identifiers indicated on the structure.

As an example, the structure may include one or more identifiers on its recto face associated with a first integrated microcircuit device and one or more identifiers on its verso face associated with a second integrated microcircuit device indicating to a user that the recto or respectively the verso face of the structure should be presented to an external reader so that it can read and possibly modify the data contained in the first or respectively the second integrated microcircuit device.

Similarly, at one of its ends the structure may include one or more identifiers associated with a first integrated microcircuit device and at its other end one or more identifiers associated with a second integrated microcircuit devices indicating to a user that one or the other end of the structure should be presented to an external reader so that it can read and possibly modify the data contained in the first or respectively the second integrated microcircuit device.

In one embodiment of the invention, the identifier or identifiers may, for example, indicate to the user the orientation of the structure or of the card containing the structure that needs to be adopted in front of the reader and/or the direction of introducing the structure or the card containing the structure into the reader as a function of the intended use of said card.

The structure may include one or more identifiers at at least one of the integrated microcircuit devices, in particular superimposed on the integrated microcircuit device.

The identifier or identifiers may act as visual means for identifying the integrated microcircuit devices and/or their function, on each face at each of the opposite ends of the structure.

The identifier or identifiers may, for example, correspond to information shown on the structure, for example printed, bonded, etched, transferred, or hand written, among others. The identifier or identifiers may, for example, be different notes, a design, a logo, a pattern, a color, or an embossed relief, or bas-relief.

The identifier or identifiers may, for example, contribute to the appearance of the structure.

The structure may result from assembling an element including one of the integrated microcircuit devices fixed to another element including the other of the integrated microcircuit devices.

The structure may also be assembled directly by the user from at least two constituent layers of the structure, each in particular including one of the integrated microcircuit devices. As an example, it may be assembled by adhesively bonding the constituent layers or by fusing or welding the constituent layers of the structure without using glue or adhesive.

The structure may also be produced from a material, in particular a sheet, including at least two integrated microcircuit devices or more, distributed in a regular or irregular manner on the material.

Advantageously, the integrated microcircuit devices are separated from each other by a distance greater than the sum of the read distances between the integrated microcircuit devices with an external reader.

A user may, for example, use such a material to produce a structure of the invention, for example by masking certain of the integrated microcircuit devices with, for example, one or more electromagnetic interference devices as a function of the desired number of integrated microcircuit devices or by cutting the material to obtain a material with the desired number of integrated microcircuit devices.

### Security Elements

The structure and/or the constituent layers of the structure may include one or more security elements.

Certain security elements can be detected with the naked eye, in daylight or under artificial light, without using a particular apparatus. These security elements comprise colored fibers or flakes, or completely or partially printed or metallized filaments. These security elements are known as first level elements.

Other types of security element can only be detected with the aid of a relatively simple apparatus such as a lamp emitting in the ultraviolet or infrared. These security elements comprise, for example, fibers, flakes, strips, filaments, or particles. These security elements may optionally be visible to the naked eye, being for example luminescent under a Wood lamp emitting at a wavelength of 365 nanometers (nm). These security elements are known as second level elements.

Other types of security elements require a more sophisticated detection apparatus for their detection.

These security elements are, for example, capable of generating a specific signal when they are subjected, simultaneously or otherwise, to one or more external sources of excitation. Automatic signal detection can authenticate the document if appropriate. These security elements comprise tracers, for example in the form of an active material, particles or fibers, capable of generating a specific signal when these tracers are subjected to optronic, electrical, magnetic, or electromagnetic excitation. These security elements are known as third level elements.

The security elements present in the structure and/or one of the constituent layers of the structure may have first, second or third level security characteristics.

The structure may in particular comprise, as security elements, among others:
luminescent dyes and/or pigments and/or interference pigments and/or liquid crystal pigments, in particular in the printed form or mixed with at least one constituent layer of the structure;
photochromic or thermochromic components, dyes and/or pigments, in particular in the printed form or mixed with at least one constituent layer of the structure;
an ultraviolet absorber (UV), in particular in coated form or mixed with at least one constituent layer of the structure;
a specific light collecting material, for example of the “waveguide” type, for example a luminescent light-collecting material such as polymer films based on polycarbonate marketed by the supplier BAYER under the trade name LISA®;
a multi-layer interference film;
a structure with variable optical effects based on interference pigments or liquid crystals;
a birefringent or polarizing layer;
a diffraction structure;
an embossed image;
means producing a “moiré effect”, said effect possibly, for example, causing a pattern produced by superimposing two security elements to appear on the structure, for example by bringing the lines of two security elements together;
a partially reflective refractive element;
a transparent lenticular grid;
a lens, for example a magnifying glass;
a colored filter;
a security filament incorporated, for example, into the bulk of at least one constituent layer of the structure or into a window, possibly including a positive or negative print, a fluorescence, a metal, a goniochromatic or holographic effect, with or without one or more demetallized portions;
a metallized, goniochromatic, or holographic foil;
a layer with a variable optical effect based on interference pigments or liquid crystals;
a flat security element with a relatively small format such as a flake, which may optionally be visible, in particular luminescent;
particles or agglomerates of particles of pigments or dyes of the HI-LITE type, which may be visible or invisible, in particular luminescent;
security fibers, in particular metal, magnetic (with a soft and/or hard magnetism), or absorbent, or excitable by ultraviolet, visible or infrared radiation, and in particular the near infrared (NIR); and
automatically readable security with specific measurable characteristics of luminescence (for example fluorescence, phosphorescence), light absorption (for example ultraviolet, visible or infrared), Raman activity, magnetism, microwave interaction, X ray interaction, or electrical conductivity.

One or more security elements as defined above may be present in the structure and/or in one or more constituent layers of the structure or in one or more security elements incorporated into the structure and/or into one or more constituent layers of the structure, such as a filament, a fiber, or a flake.

At least one of the constituent layers of the structure may also include a first level security element such as a watermark or a pseudo-watermark at least partially superimposed over a translucent region of the structure.

The term “watermark or pseudo-watermark” as used in the invention means a drawn image that appears in the thickness of the structure.

The watermark or pseudo-watermark may be produced in different manners known to the skilled person.

To this end, the structure may include at least one fibrous or polymer layer, a sub-structure, an adhesive layer, an outer layer, or a spacer layer as defined below.

In particular, the structure may include:
one or more fibrous layers;
a sub-structure including a transparent or translucent region; and
one or more watermark or pseudo-watermarks carried by at least the fibrous layers, the fibrous layers or the sub-structure including at least two contactless integrated microcircuit devices, advantageously separated from each other by a distance greater than the sum of the read distances of the integrated microcircuit devices with an external reader, or separated from each other by an electromagnetic interference system.

When each of two fibrous or polymer layers includes a respective watermark or pseudo-watermark, the two watermarks or pseudo-watermarks may be different. In particular, the watermarks or pseudo-watermarks may be complementary in their visual effects or relative to a concept or an image.

In one embodiment of the invention, each of two constituent outer layers of the structure may include a respective watermark or pseudo-watermark and the structure may include a transparent zone such that the two watermarks combine visually in a transparent region of the sub-structure when the structure is observed in transmitted light, causing a new pattern to appear.

Advantageously, the two outer layers including the watermarks or pseudo-watermarks are fibrous layers. In another embodiment, the outer layers including the watermarks or pseudo-watermarks are polymer layers.

In a variation, each of the two watermarks or pseudo-watermarks is at least partially superimposed in the transparent region of the structure.

In a particular embodiment of the invention, the sub-structure may be an electromagnetic interference system produced from a transparent material so as to allow light to pass through and allow the watermarks to combine visually when the structure is observed in transmitted light.

In another embodiment of the invention, two constituent layers of the structure may each include a respective watermark or pseudo-watermark and the structure may include a translucent but not transparent zone such that each of the two watermarks or pseudo-watermarks can be observed only in light transmitted through the structure in the translucent region and from the face of the structure that is adjacent to the outer layer that carries the watermark or pseudo-watermark.

Advantageously, the two outer layers including the watermarks or pseudo-watermarks are fibrous layers. In another embodiment, the outer layers including the watermarks or pseudo-watermarks are polymer layers.

In a variation, each of the two watermarks or pseudo-watermarks is at least partially superimposed in the translucent region of the structure.

In particular, one of the outer layers may include a first watermark or pseudo-watermark visible on a first face representing a national emblem and the other outer layer may include a second watermark or pseudo-watermark visible on the other face and in the form of an inscription, for example the corresponding national device. With a gift card, one of the watermarks may represent the logo of the issuing firm and the other watermark may represent the value of the card.

In one embodiment of the invention, the two watermarks or pseudo-watermarks face each other at least in part.

In a particular embodiment of the invention, the structure may include a translucent zone and the two watermarks or pseudo-watermarks are identical but placed in a symmetrical manner. Then for authentication purposes, the two watermarks or pseudo-watermarks on the two faces of the structure can be checked to ensure that they are identical. As an example, the same text may be read on both faces, or a person may be observed with the head always turned to the same side.

In another embodiment of the invention, a single outer constituent layer of the structure may include a. watermark or a pseudo-watermark and the structure may include a translucent but non-transparent region such that the watermark can be observed only in light transmitted through the structure in the translucent region from the face of the structure adjacent to the fibrous layer.

Security and/or Identity Document

In another aspect, the invention provides a security and/or identity document including the structure as defined above.

The security and/or identity document may, for example, be a passport, an identity card relating to an object or to a person, in particular an identity card, a driving license, an interactive playing card or card for collecting, a payment means, in particular a payment card, a gift card or a voucher, a transport card, a loyalty card, a benefit card, or a subscription card.

In particular, the card may be a multiple-application card such as:
a social security card both for enabling a pharmacist to transmit to the national health insurance authorities information relating to the health costs of the holder of the card, and also for sharing the pharmaceutical file relating to the cardholder between various pharmacists and physicians;
a student card also acting as a photocopy card and/or a canteen card and/or a library card;
a card for access to cultural or sporting events or to shows and also acting as a transport card;
a subscription card also acting as a payment card; and
a playing card showing different values, in particular as many different values as there are integrated microcircuit devices.

In particular, the document may be a passport including a leaf constituted by the structure of the invention and including an electromagnetic interference system as defined above.

Such an identity document can act both as a passport and also as a visa, a first integrated microcircuit device including the digitized photograph of the passport holder together with personal data, and a second integrated microcircuit device that is distinct from the first including the authorizations to enter a particular country. The first device may be read-only and the second may be read/writable in order to allow visas to be updated.

The passport constituted thereby may also include a second electromagnetic interference system located between the passport cover and an end paper of the passport. In this manner, when the passport is closed, i.e. folded up, it is impossible to read either of the two integrated microcircuit devices because of the presence of the second electromagnetic interference system between the cover and the end paper.

Further, when the passport is open, only one of the integrated microcircuit devices can be read as a function of the position of the leaf constituted by the structure relative to the reader, i.e. depending on whether the face of the leaf presented to the reader is the recto face or the verso face.

### Ensemble

In a further aspect, the invention provides an ensemble comprising the structure as defined above and the external reader.

The external reader is capable of reading or even modifying the data contained in the integrated microcircuit devices, in the circumstances described above.

In particular, the ensemble may include a structure of the invention for self-assembly.

As an example, the ensemble may include a plurality of assembly elements, each including at least one integrated microcircuit device, and the structure may be produced by uniting at least two of these assembly elements, in particular by adhesive bonding or by fusion or by welding.

The assembly elements may in particular include integrated microcircuit devices all containing respective different data or data associated with respective different application programs of the structure. As an example, each assembly element may be associated with a unique application program, for example as a canteen card, a photocopy card, a student card, a library card, a transport card, among others.

### Method

In another aspect, the invention provides a method of reading a structure of an ensemble as defined above, the method comprising the step consisting in using the external reader to read, receive, or even modify the data of a single integrated microcircuit device at any one time.

In particular, the data from the two integrated microcircuit devices read by an external reader may correspond to two different application programs, for example for a photocopy card and a canteen card, or for a student card and a transport card.

In particular, reading one of the integrated microcircuit devices may be conditional upon reading the other of the integrated microcircuit devices, in particular upon the result of reading that device.

Reading the two integrated microcircuit devices may also allow successive authentication of the structure. In particular, if the first result of reading one of the integrated microcircuit devices does not correspond to the expected result, reading of the second integrated microcircuit devices may optionally be authorized so as to carry out an additional step of authenticating the structure (basic access control).

The invention can be better understood from the following detailed description of non-limiting embodiments thereof and from the accompanying diagrammatic and fragmentary figures in which:

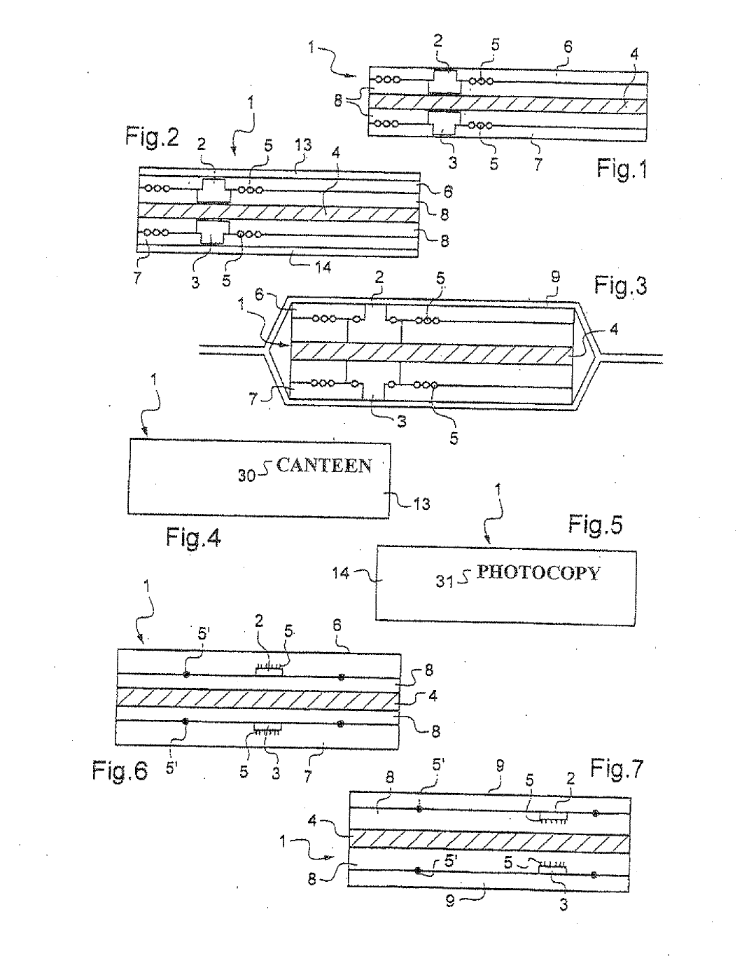

FIGS. 1, 2, and 3 show, in section, three examples of the structure of the invention;

FIGS. 4 and 5 respectively represent the recto and the verso faces of the structure of FIG. 2;

FIGS. 6 and 7 show, in section, two variations of a structure of the invention;

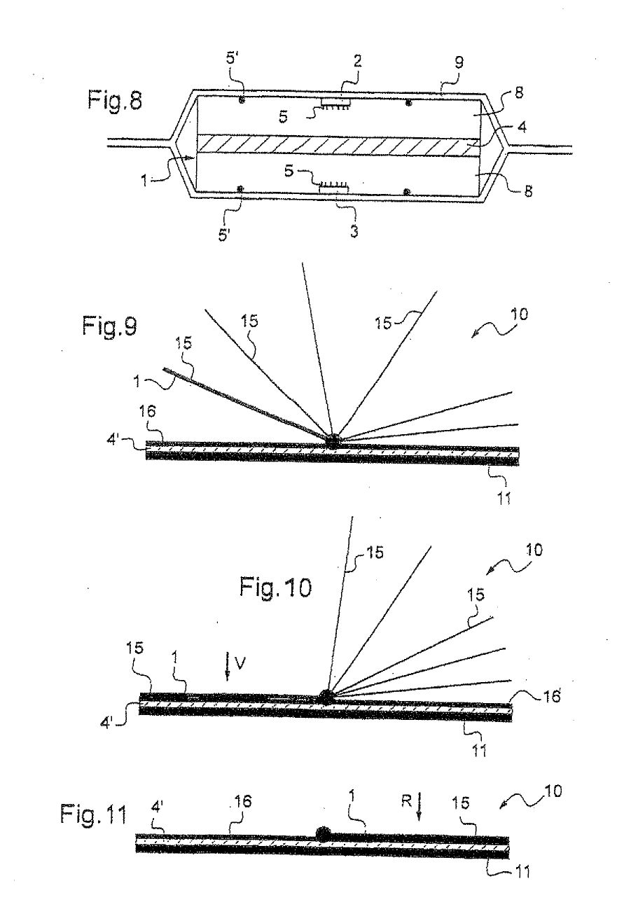

FIG. 8 shows another variation of a structure of the invention;

FIGS. 9, 10, and 11 show, in section, an example of a passport including a structure of the invention;

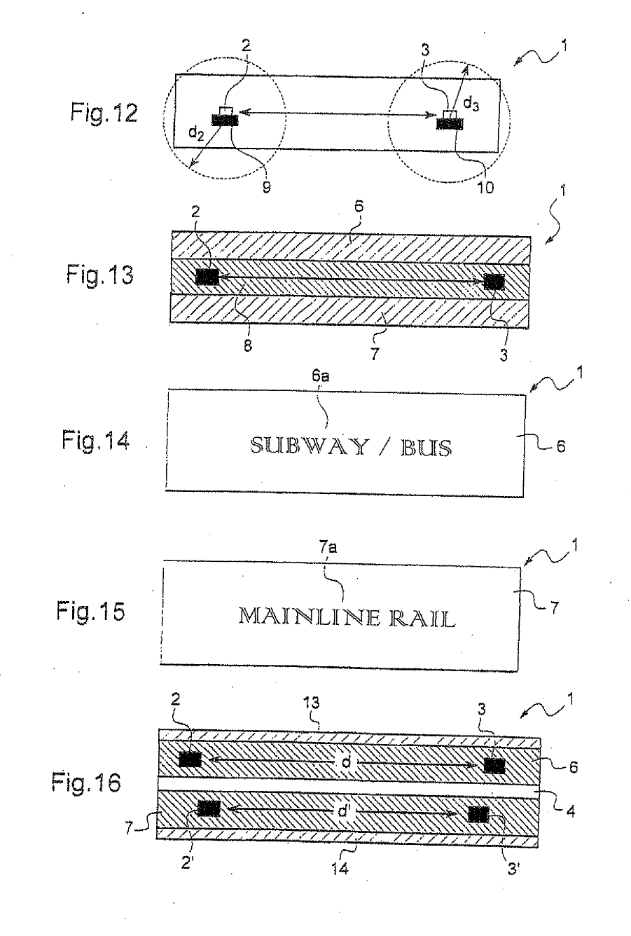

FIG. 12 shows, in section, another example of a structure of the invention;

FIG. 13 shows, in section, another example of a structure of the invention;

FIGS. 14 and 15 respectively show the recto and verso faces of the structure of FIG. 13;

FIG. 16 shows another example of a structure of the invention;

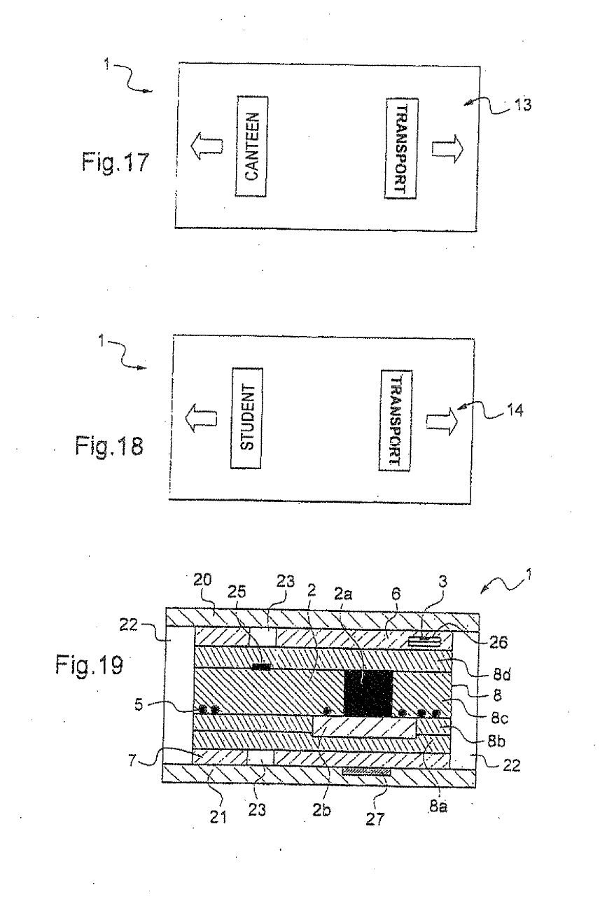

FIGS. 17 and 18 respectively show the recto and verso faces of the structure of FIG. 16;

FIG. 19 shows another example of a structure of the invention;

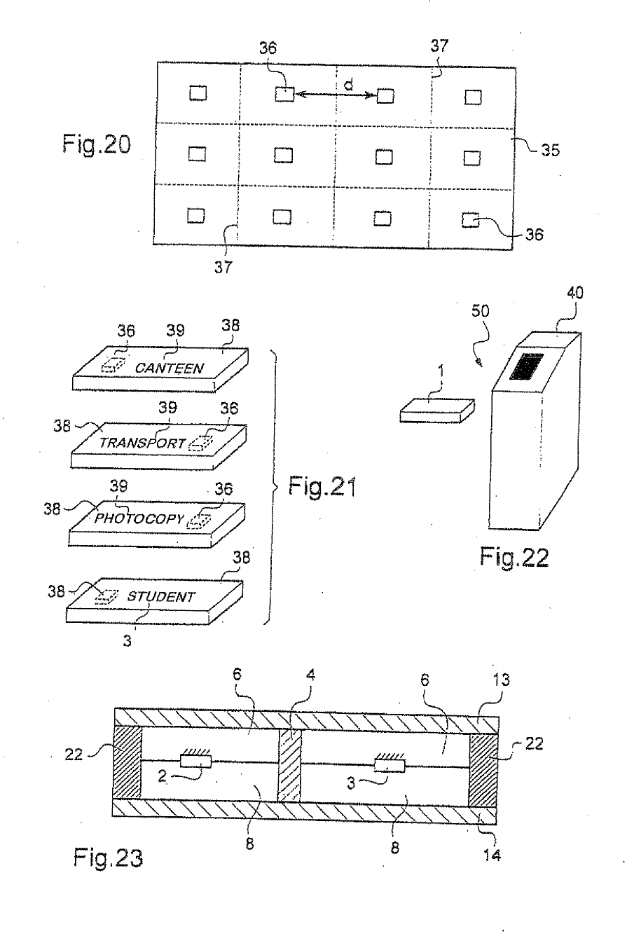

FIG. 20 shows an example of a material provided with integrated microcircuit devices that may be used to produce a structure of the invention;

FIG. 21 shows an example of assembly elements that may be used to produce a structure of the invention;

FIG. 22 shows an example of an ensemble of the invention; and

FIG. 23 is an analogous view to FIG. 1 of a variation of the invention.

In the drawings, for the purposes of clarity, the relative proportions of the various elements shown are not always the same.

FIG. 1 shows an example of a structure 1 in accordance with the invention.

The structure 1 includes two integrated microcircuit devices constituted by chips 2 and 3, each provided with an antenna 5, and wholly incorporated between the outer layers 6 and 7 and the inner layers 8 of the structure 1, the inner layers 8 being separated by an electromagnetic interference system 4.

In this example in particular, the integrated microcircuit devices are in contactless communication and in particular comprise chips 2 and 3 of the MOB chip module 6 type, marketed by the supplier PHILIPS. The antennas 5 are, for example, of the copper wire type. Furthermore, the chips 2 and 3 and their respective antennas 5 are placed facing each other in a symmetrical manner relative to the center of the structure 1. In a variation, the integrated microcircuit devices could be positioned in a different manner.

In this example, the layers 6, 7 and 8 of structure 1 may be fibrous and/or polymer structures, for example layers of paper and/or plastics material. The thicknesses of these layers 6, 7 and 8 in this example are identical but they may also be different.

The layers 6 and 7 have recesses to accommodate the MOB chip module 6 in their thickness.

In this example, the electromagnetic interference system 4 is a system for total or partial attenuation of the coupling of the integrated microcircuit devices with the external reader as a function of their position in front of the external reader. The attenuation system may, for example, be a layer of zinc sprayed onto the inner face of at least one of the layers 8 constituting the structure.

The integrated microcircuit devices are placed either side of the electromagnetic interference system 4 so that it is impossible for an external reader to read both integrated microcircuit devices simultaneously.

In fact, when the recto face of the structure 1 corresponding to the layer 6 is presented in front of the reader, only the integrated microcircuit device including the chip 2 can be read by an external reader. Similarly, when the verso face of the structure 1 corresponding to the layer 7 is presented in front of the reader, only the integrated microcircuit device including the chip 3 can be read by an external reader.

FIG. 2 shows the structure 1 of FIG. 1, additionally including two outer layers 13 and 14.

The outer layers 13 and 14 are, for example, fibrous and/or polymer layers, for example layers of paper and/or plastics material. The layers 13 and 14 are advantageously printable and in particular opaque layers.

In this manner, the presence of the outer layers 13 and 14 can mask the integrated microcircuit devices and optionally the electromagnetic interference system 4.

The structure 1 of FIG. 2 may, for example, enable it to be used as a multiple-application card when it is intended to correspond to or be incorporated into a security and/or identity document. As an example, the structure 1 may act as an interactive playing card or a “dual application program” card, for example both a photocopy card and a canteen card, or both a student card and a library card.

Each face of the structure 1 may thus include one or more identifiers that, for example, can allow a user to tell which face is to be presented to an external reader depending on the desired use of the structure 1.

In particular in this example, the data contained in the chip 2 may correspond to data or to application programs linked to use of the structure 1 as a canteen card and to this end, the recto face of the structure 1 may include an identifier in the form of printing 30 showing the word “canteen”, as can be seen in FIG. 4.

Similarly, the data contained in the chip 3 may correspond to data or to application programs linked to use of the structure 1 as a photocopy card and to this end, the verso face of the structure 1 may include an identifier in the form of printing 31 showing the word “photocopy”, as can be seen in FIG. 5.

FIG. 3 shows the structure 1 of FIG. 1, additionally including an outer protective layer 9. This protective layer, shown in the figure in the form of a pouch, may also be in the form of a laminate, depending on the document to be protected. This layer 9, in particular formed from a polymer, may be provided on its inner face with a heat seal or pressure-sensitive adhesive to allow it to be laminated to the structure 1. The outer layer 9 is a transparent layer. The layer 9 is advantageously a secure layer of polyester or polypropylene marketed by the supplier Fasver under the trade name Fasfilm.

FIG. 6 shows a variation of the structure 1 of the invention with integrated microcircuits constituted by chips 2 and 3 of the ADE (antenna on-board) type provided with their on-board antennas 5 and booster antennas 5′ to increase the reading distance of said chips.

Chips 2 and 3, their on-board antennas 5, and the booster antenna 5′ are wholly incorporated between the outer layers 6 and 7 and the inner layers 8 of the structure 1, the inner layers 8 being separated by an electromagnetic interference system 4.

In this particular example, the integrated microcircuit devices are in contactless communication and are in particular constituted by MM chip type chips 2 and 3 marketed by the supplier FEC. The AOB chips 2 and 3, their on-board antennas 5 and their booster antennas 5′ printed on the outer faces of the layers 8 are placed facing each other and symmetrically relative to the center of the structure 1. In a variation, the devices 2 and 3 may be positioned differently.

In this example again, the layers 6, 7 and 8 of the structure 1 may be fibrous and/or polymer layers, for example layers of paper and/or plastics material. The thicknesses of these layers 6, 7 and 8 in this example are identical, but they may also be different.

On their outer faces in contact with the layers 6 and 7, the layers 8 carry the chips 2 and 3 and their on-board antennas 5 fixed by a dot of adhesive as well as the booster antennas 5′, for example printed by serigraphy.

The electromagnetic interference system 4 in this example is a system for total or partial attenuation of the coupling of the integrated microcircuit devices with the external reader as a function of their position in front of the external reader. The attenuation system may, for example, be a thin film of aluminum placed between the layers 8 constituting the structure.

The chips 2 and 3, their on-board antennas 5 and their booster antennas 5′ are placed either side of the electromagnetic interference system 4 such that simultaneous reading of the two chips 2 and 3 by an external reader is impossible.

On the recto face of the structure 1 corresponding to the layer 6, only the chip 2 can be read by an external reader. Similarly, on the verso face of the structure 1 corresponding to the layer 7, only the chip 3 can be read by an external reader.

FIG. 7 shows a variation of FIG. 6 of the invention with integrated microcircuits constituted by chips 2 and 3 of the AOB type, their on-board antennas 5 and booster antennas 5′ to increase the reading distance of said chips. In this variation, the contactless microcircuit devices and their booster antennas 5′ are carried directly by transparent outer protective layers 9 and not any longer by the constituent layers 8 of the structure.

The outer layers 9 are, for example, laminates in the form of a transparent film marketed under the trade name Smartfilm by the supplier Fasver.

The layers 8 are fibrous layers that can be printed and personalized, for example formed from Jetguard paper marketed by the supplier Arjowiggins.

The integrated microcircuit devices constituted by the chips 2 and 3 and their on-board antennas 5 are placed either side of the electromagnetic interference system 4 such that it is impossible for an external reader to read both of the integrated microcircuit devices simultaneously.

FIG. 8 shows another example of a structure of the invention. In this example, integrated microcircuit devices constituted by chips 2 and 3 of the AOB type and their on-board antennas 5 are carried by a transparent security film 9. The inner face of the film 9 carrying the integrated microcircuit devices is brought into contact with the layers 8 of the structure. Such a film is, for example, marketed under the trade name Smartfilm by the supplier Fasver.

A booster antenna 5′ may also be printed on the inner face of the film 9 to enable the distance for reading the AOB chips to be increased.

In another example, not shown, integrated microcircuit devices constituted by AOB type chips 2 and 3, their on-board antennas 5 and possibly their booster antennas 5′ may be carried by a security foil, for example a security foil having an optical effect. In the same manner as in the example of FIG. 8, the inner face of the foil carrying the integrated microcircuit devices is brought into contact with the layers 8 of the structure.

FIGS. 9, 10, and 11 show a passport 10 incorporating a structure 1 of the invention, in particular a structure such as that shown in FIG. 1.

The passport 10 comprises a cover 11, for example a textile or paper cover, one of the leaves 15 of which corresponds to or has integrated into it the structure 1 of the invention. In this example, the structure 1 corresponds to a leaf 15, for example the page of data relating to the bearer, not located between two other leaves 15. Clearly, the structure 1 could correspond to any of the leaves 15.

In this example, the passport 10 includes a second electromagnetic interference system 4′ located between the cover 11 of the passport 10 and an end paper 16 of the passport 10. The second electromagnetic interference system 4′ may be identical to the electromagnetic interference system 4 described above or it may be different. Further, the end paper 16, the electromagnetic interference system 4′ and the cover 11 may be assembled together, in particular by bonding, so as to define a new cover for the passport 10 inside which are the leaves 15.

In this example, the electromagnetic interference system 4′ extends over the whole surface of the cover 11 of the passport. In a variation, the electromagnetic interference system 4′ could extend over only a portion of the cover 11 of the passport 10.

In another variation, the passport 10 could be without an electromagnetic interference system 4′.

When the passport 10 is closed, reading the integrated microcircuit devices included in the structure 1 of leaf 15 is impossible because of the presence of the electromagnetic interference system 4′.

When the passport 10 is open and the structure 1 is placed with its recto face, on which the chip 2 is mounted, against the end paper 16 of the passport, as illustrated in FIG. 10, only the chip 3 can be read by an external reader placed on the verso face of the structure 1 (as represented by the arrow V in FIG. 10), due to the presence of the electromagnetic interference systems 4 and 4′.

When the passport 10 is open and the structure 1 is placed with its verso face, on which the chip 3 is mounted, against the end paper 16 of the passport, as can be seen in FIG. 11, only the chip 2 can be read by an external reader placed on the recto face of the structure 1 (as represented by the arrow R in FIG. 11), because of the presence of the electromagnetic interference systems 4 and 4′.

In a variation, the structure 1 could include outer layers, as described in FIG. 2. The structure 1 could again correspond to a structure such as that described for FIG. 12, without the electromagnetic interference system. In this case, the value of the distance d separating the two integrated microcircuit devices 2 and 3 is what prevents an external reader from simultaneously reading the two integrated microcircuit devices.

FIG. 12 shows another example of a structure 1 in accordance with the invention.

In this example, the structure 1 is a mono-layer constituted, for example, by a polymer or fibrous layer.

The structure 1 includes two integrated microcircuit devices constituted by AOB type chips 2 and 3 and their on-board antennas, not shown in this figure, such as MM chips marketed by the supplier FEC separated from each other by a distance d.

Advantageously, the distance d is greater than the sum of the distances d₂ and d₃ for reading chips 2 and 3 with an external reader, such that any simultaneous reading of the two chips 2 and 3 by the reader is impossible.

The two chips 2 and 3 and their on-board antennas are respectively carried by two 5 mm wide security filaments 9 and 10 incorporated, for example, by the papermaking machine into the bulk of the paper in the machine direction, using a method that is well known to the skilled person.

FIG. 13 shows another example of a structure 1 of the invention.

The structure 1 includes two fibrous layers 6 and 7 and a sub-structure 8 located between the fibrous layers 6 and 7.

The fibrous layers 6 and 7 each include a watermark, respectively 6a and 7a, representing, for example, the texts “SUBWAY/BUS” and “MAINLINE TRAIN” as shown in FIGS. 14 and 15. The watermarks 6a and 7a face each other.

In this example again, the sub-structure 8 corresponds to a translucent layer that diffuses light and includes two integrated microcircuit devices, for example in the form of two AOB chips 2 and 3, located at opposite ends of the structure 1 and separated by a distance d that is greater than the sum of the distances for reading the chips 2 and 3 with an external reader.

The thickness of each integrated microcircuit devices is of the order of 75 μm. In a variation, the structure 1 could include more than two integrated microcircuit devices, for example three or four.

In this example, the two integrated microcircuit devices are separated from each other by a distance d equal to 10 mm.

The sub-structure 8 advantageously includes a translucent region with a thickness and refractive index suitable for diffusing light. In this example, the translucent region extends over the whole of the sub-structure 8 and thus can prevent any visual combination of the watermarks 6a and 7a of the fibrous layers 6 and 7 by observation in transmitted light.

FIGS. 14 and 15 show respectively the recto and the verso faces of the structure 1 of FIG. 13 as observed in transmitted light.

In FIG. 14, it can be seen that observation in transmitted light of the recto face of the structure 1 means that only the watermark 6a of the fibrous layer 6 can be observed. Similarly, in FIG. 15 it can be seen that observation in transmitted light of the verso face of the structure 1 means that only the watermark 7a of the fibrous layer 7 can be observed.

In this manner, combination of the watermarks 6a and 7a of the fibrous layers 6 and 7 is impossible in this case due to the presence of the translucent, light-diffusing sub-structure 8.

FIG. 16 shows another example of a structure 1 of the invention.

The structure 1 includes four integrated microcircuit devices constituted by chips 2, 2′, 3, and 3′ of the AOB type and their on-board antennas, not shown in this figure, completely incorporated into the layers 6 and 7 of the structure 1, the layers 6 and 7 being separated by an electromagnetic interference system 4.

The two integrated microcircuit devices incorporated into the layer 6 are located at opposite ends of the layer 6 and separated by a distance d greater than the sum of the distances for reading the chips 2 and 3 with an external reader. The two devices incorporated into the layer 7 are also located at opposite ends of the layer 7 and separated by a distance d′ greater than the sum of the distances for reading the chips 2′ and 3′ with an external reader. The distances d and d′ may be identical or different.

The outer layers 13 and 14 are, for example, fibrous layers and/or polymers, in particular layers of paper and/or plastics material. The layers 13 and 14 are advantageously printable layers; in particular, they are opaque.

The structure 1 of FIG. 16 enables multiple-application use when it is intended to correspond to or to be incorporated into a security and/or identity document.

Each face of the structure 1 may thus include several identifiers enabling, for example, a user to tell which face of the document is to be presented and in which orientation (left side, right side, recto face, verso face) to an external reader depending on the desired use of the structure 1.

In particular in this example, the data and application programs contained in the chip 2 may correspond to data and application programs linked to using the structure 1 as a canteen card and the data and application programs contained in the chip 3 may correspond to data and application programs linked to using the structure 1 as a photocopy card. For this reason, the recto face of the structure 1 may include printing 30 on its left hand side representing the word “CANTEEN” and printing 31 on its right hand side showing the word “PHOTOCOPY”, as can be seen in FIG. 17.

Similarly, the data and application programs contained in the chip 2′ may correspond to data and application programs linked to using the structure 1 as a student card and the data and application programs contained in the chip 3′ may correspond to data and application programs linked to using the structure 1 as a transport card. For this reason, the verso face of the structure 1 may include an identifier in the form of printing 30′ on its right hand side representing the word “TRANSPORT” and an identifier in the form of printing 31′ on its left hand side representing the word “STUDENT”, as can be seen in FIG. 18.

FIG. 19 shows another example of a structure 1 of the invention.

The structure 1 includes two fibrous layers 6 and 7 between which a sub-structure 8 is located, comprising an integrated microcircuit device with contactless communication constituted by the chip module 2 and the antenna 5 carried by the sub layer 8b.

The fibrous layer 6 includes a security filament 26 in the form of two laminated flat strips with a width of 2 mm, one of the strips having a recess in which an integrated microcircuit device, for example in the form of an AOB chip 3, is partially housed. The filament 26 may be completely incorporated into the bulk of the fibrous layer 6 or it may be introduced into a window in the manner of a “window thread” such that it is flush with the outer face of the layer 6 in regions.

The security filament 26 may also include one or more security elements.

The structure 1 also includes two outer layers 20 and 21 respectively covering the fibrous layers 6 and 7, and a spacer layer 22 located between the outer layers 20 and 21, especially in order to compensate for the differences in width between the outer layers 20 and 21 and the fibrous layers 6 and 7 of the sub-structure 8.

In this example, the outer layers 20 and 21 are transparent polymer layers and the spacer layer is a polycarbonate layer.

In this example, the sub-structure 8 is entirely translucent and diffuses light and includes four layers 8a, 8b, 8c, and 8d.

The layer 8d is, for example formed from polycarbonate with a thickness of 130 μm, and on its inner face it includes printing 25, for example fluorescing yellow under ultraviolet (UV) at 365 nm.

The layer 8c is, for example, formed from polycarbonate with a thickness of 200 μm, and has a recess in which a portion 2a of the chip 2 is housed corresponding, for example, to the potting of a MOB type module 4 marketed by the supplier NXP, a subsidiary of the supplier PHILIPS. The layer 8c includes the antenna 5 associated with the chip 2 on its inner face.

The layer 8b may, for example, be formed from polycarbonate with a thickness of 130 μm and have a recess in which a portion 2b of the chip 2 is housed corresponding, for example, to the base of a MOB type module 4.

The layer 8a is formed from polycarbonate with a thickness of 100 μm, for example.

The fibrous layers 6 and 7 each, for example, include a recess 23, facing each other and facing the fluorescent print 25 of the layer 8d of the sub-structure 8. The recesses 23 enable a transparent window to be formed that is observable, for example, in reflection and in transmission, from both sides of the structure 1. The recesses 23 forming the transparent window may, for example, have the form of a medallion. The fibrous layer 6 may; for example, include one or more security elements, for example visible blue fiberettes, or invisible flakes that fluoresce green under ultraviolet (UV) at 365 nm. The fibrous layer 7 may also include one or more security elements, for example invisible red fluorescing fiberettes, invisible blue fluorescing flakes, or invisible HI-LITEs that fluoresce orange under ultraviolet (UV) at 365 nm.

The fibrous layer 7 may also include a holographic foil 27, for example applied by hot transfer, protected by the outer layer 21 and located in particular outside the recess 23. The foil 27 may, for example, have a thickness of 6 μm and does not need to be compensated for in thickness.

The spacer layer 22 may, for example, be formed from transparent polycarbonate that fluoresces red under ultraviolet (UV) at 365 nm.

When observed in daylight in reflection, then, on the side of the outer layer 20 it is possible to observe the blue fiberettes and the security filament 26 and on the side of the outer layer 21, the holographic foil 27 and blue flakes can be observed.

When observed under ultraviolet light in reflection, it is possible, for example, to see the transparent edges of the structure 1 corresponding to the width of the spacer layer 22 that fluoresces red and the yellow fluorescent printing 25 at the window formed by the recesses 23. It is also possible to see the luminescent security elements at the fibrous layers 6 and 7, since the security elements (fibers, HI-LITE flakes) have a different luminescence depending on which face of the structure 1 is being observed.

Advantageously, the distance d separating the two integrated microcircuit devices is greater than the sum of the read distances for the integrated microcircuit devices with the external reader, such that simultaneous reading of the two integrated microcircuit devices by the same external reader is impossible.

FIG. 20 shows an example of a material 35 including several integrated microcircuit devices 36 that may be used to produce a structure of the invention.

The material 35 may, for example, correspond to a sheet including several integrated microcircuit devices 36 distributed in a regular manner on the sheet and separated by a distance greater than the sum of the distances for reading the integrated microcircuit devices 36 by an external reader.

A user may thus use the material 35 as a constituent layer of a structure of the invention, either as it is presented, or by reducing the number of integrated microcircuit devices 36 that are to be integrated into the structure. The user may then elect to cut the material along the dotted lines 37 marked on the material 35 or to place on certain of the integrated microcircuit devices 36 one or more electromagnetic interference systems, for example in the form of strips or patches, which may optionally be self-adhesive.

The distance between the integrated microcircuit devices 36 is sufficiently large on the material 35 relative to the distances for reading said devices by an external reader, and so simultaneous reading of more than one integrated microcircuit device by an external reader is impossible even after reducing the number of devices 36.

FIG. 21 shows examples of assembly elements 38 each including an integrated microcircuit device 36. Preferably, all of the integrated microcircuit devices 36 of these assembly elements 38 are different.

Each assembly element 38 is associated with a desired function, for example a canteen card, a photocopy card, etc, indicated by the identifiers 39 on the assembly elements 38.

A user may thus produce a personalized structure by assembling at least two of said assembly elements 38, for example to produce a canteen and photocopy card, or a canteen and transport card.

FIG. 22 shows an example of the ensemble 50 of the invention comprising a structure 1 of the invention that may be as described above, and an external reader 40 to read the data contained in the integrated microcircuit devices of the structure 1.

The structure 1 of the invention shown in FIG. 23 includes two chips 2 and 3, for example of the AOB type.

The chips 23 are, for example, each sandwiched between two layers 6 and 8, for example layers of a synthetic material, for example polycarbonate.

The layers 6 and 8 associated with each chip are, for example, identical to those associated with the other layer, and in particular may have the same composition and the same thickness.

Each stack of layers 6 and 8 is separated from the other by an electromagnetic interference system 4. By way of example, this system is a strip of a metal, for example aluminum, said strip being thicker than it is wide, for example, the thickness being measured perpendicular to the plane of the structure 1.

The stacks of layers 6, 8 and the interference system 4 may be sandwiched between two outer layers 13 and 14. Spacers 22 may be disposed between the layers 13 and 14, either side of the assembly of the layers 6, 8 and the interference system 4. These spacers 22 have the same thickness as the cumulative thickness of the layers 6 and 8, for example.

The expression “comprising a” is synonymous with “comprising at least one” unless otherwise specified.

1-25. (canceled)

26. A structure comprising at least two distinct integrated microcircuit devices with contactless communication, each comprising at least one chip and at least one antenna, said at least two integrated microcircuit devices being disposed in or on the structure such that, in at least one position of the structure relative to an external reader, any simultaneous reading of more than one of the integrated microcircuit devices by the external reader is impossible.

27. A structure according to claim 26, said at least two integrated microcircuit devices being separated in pairs by a distance greater than the sum of the read distances for reading the integrated microcircuit devices with an external reader and/or are separated by an electromagnetic interference system.

28. A structure according to claim 27, the distance being 10 mm or more.

29. A structure according to claim 26, at least two of the integrated microcircuit devices being adjacent to the opposite ends of the structure.

30. A structure according to claim 26, at least two of the integrated microcircuit devices being positioned on opposite faces of the structure.

31. A structure according to claim 27, the electromagnetic interference system being constituted by or comprising at least a magnetic material, a conductive material, or a resonator circuit.

32. A structure according to claim 26, at least one of the integrated microcircuit devices including an on-board antenna on the chip.

33. A structure according to claim 26, at least one of the integrated microcircuit devices including a booster antenna.

34. A structure according to claim 26, said at least two integrated microcircuit devices each including a booster antenna.

35. A structure according to claim 34, the booster antennas being separated in pairs by a distance greater than the sum of the read distances for reading the integrated microcircuit devices with an external reader and/or being separated in pairs by an electromagnetic interference system.

36. A structure according to claim 26, at least one of the integrated microcircuit devices being carried by a security filament or a security strip incorporated into the structure.

37. A structure according to claim 26, that is mono-layer or multi-layer.

38. A structure according to claim 37, the constitutive layers being fibrous and/or polymers.

39. A structure according to claim 26, at least one of the integrated microcircuit devices being carried by a transparent security film or a security foil having an optical effect laminated onto the outer face of a constituent layer of the structure.

40. A structure according to claim 26, the two integrated microcircuit devices including different data and/or allow access to different databases or application programs.

41. A structure according to claim 26, including a plurality of identifiers on the recto and verso faces respectively associated with the integrated microcircuit devices.

42. A structure according to claim 26, including one or more security elements.

43. A structure according to claim 42, including one or more watermarks or pseudo-watermarks.

44. A structure according to claim 26, two integrated microcircuit devices being disposed either side of an electromagnetic interference system that is thicker than it is wide.

45. A structure according to claim 44, each device being sandwiched in an assembly of two inner layers.

46. A structure according to claim 44, the interference system being a metal strip.

47. A security and/or identity document including the structure as defined in claim 26.

48. A document according to claim 47, being a passport, an identity card, a driving license, an interactive playing card or card for collecting, a payment means, a gift card or a voucher, a transport card, a loyalty card, a benefit card, or a subscription card.

49. An ensemble comprising the structure as defined in claim 26 and the external reader.

50. A method of reading a structure of an ensemble as defined in claim 49, the method comprising the step consisting in using the external reader to read, receive, or even modify the data of a single integrated microcircuit device at any one time.

51. A reading method according to claim 50, the reading of one of the integrated microcircuit devices being conditional on the result of reading the other integrated microcircuit device.
